(19) United States
(12) Patent Application Publication
(10) Pub. No.: US 2017/0366490 A1
(43) Pub. Date: Dec. 21, 2017

(54) SYSTEMS AND METHODS FOR ALTERATION OF CONTENT

(71) Applicant: Lenovo (Singapore) Pte. Ltd., New Tech Park (SG)

(72) Inventors: Amy Leigh Rose, Chapel Hill, NC (US); Gary David Cudak, Wake Forest, NC (US); Bryan Loyd Young, Tualatin, OR (US); Nathan J. Peterson, Oxford, NC (US); John Scott Crowe, Durham, NC (US); Jennifer Lee-Baron, Morrisville, NC (US)

(21) Appl. No.: 15/186,792

(22) Filed: Jun. 20, 2016

(51) Int. Cl. H04L 12/58

(52) U.S. Cl. CPC H04L 51/063; H04L 51/08

(57) ABSTRACT

In one aspect, a device includes a processor and storage accessible to the processor. The storage bears instructions executable by the processor to identify content in a message that is to altered, alter the content in the message, and provide at least a portion of the message to a recipient.

### FIELD

The present application relates generally to alteration of content based on the content's relevance to a user and/or based on at least one user action.

### BACKGROUND

As recognized herein, sometimes, messages such as emails that are to be sent to a recipient are too large to be transmitted and/or received, sometimes owing to a large file attached to the message and sometimes owing to the amount of data in the message body itself. When this occurs, the message is undeliverable to the recipient. As also recognized herein, there are currently no adequate, efficient, and convenient solutions to the foregoing computer-related problem.

### SUMMARY

Accordingly, in one aspect a device includes a processor and storage accessible to the processor. The storage bears instructions executable by the processor to identify content in a message that is to altered, alter the content in the message, and provide at least a portion of the message to a recipient.

In another aspect, a method includes identifying content in a message that is to be altered, altering the content in the message, and providing at least a portion of the message to a recipient.

In still another aspect, a computer readable storage medium that is not a transitory signal comprises instructions executable by a processor to identify data that is to be altered based at least in part on one or more of a whether the data is relevant to a user and at least one previous action of the user. The instructions are also executable by the processor to alter the data based on the identification.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIGS. 3 and 4 are flow charts of example algorithms in accordance with present principles; and

FIGS. 5-8 are example user interfaces (UIs) in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

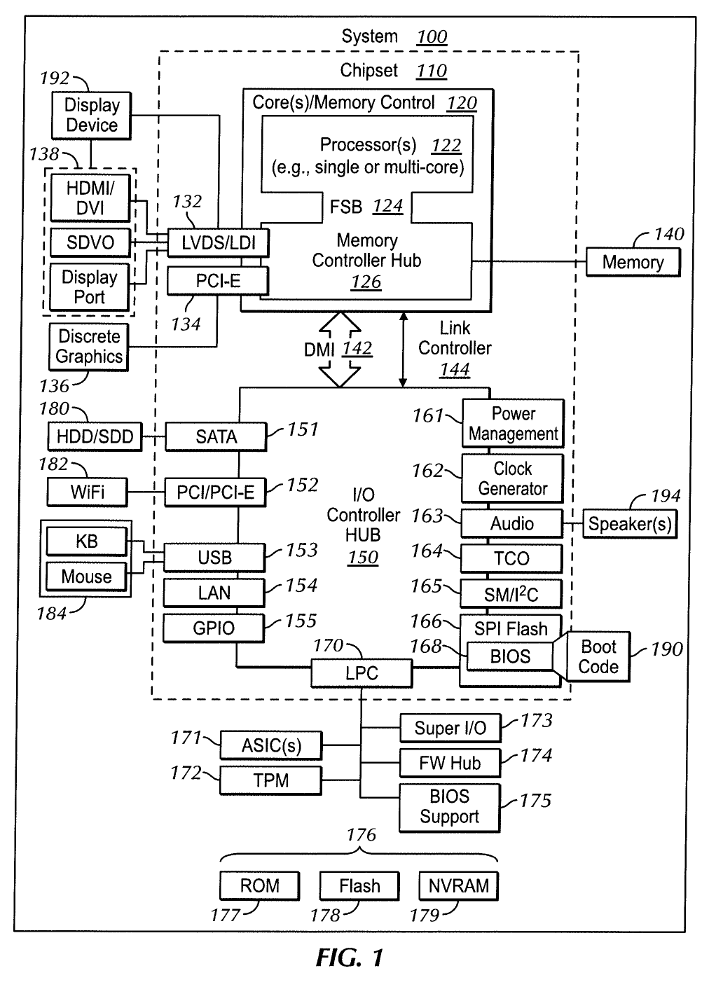

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

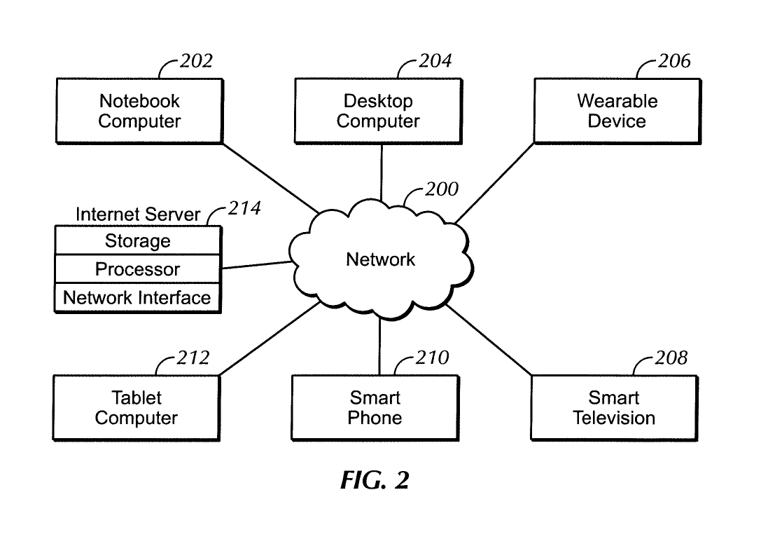

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

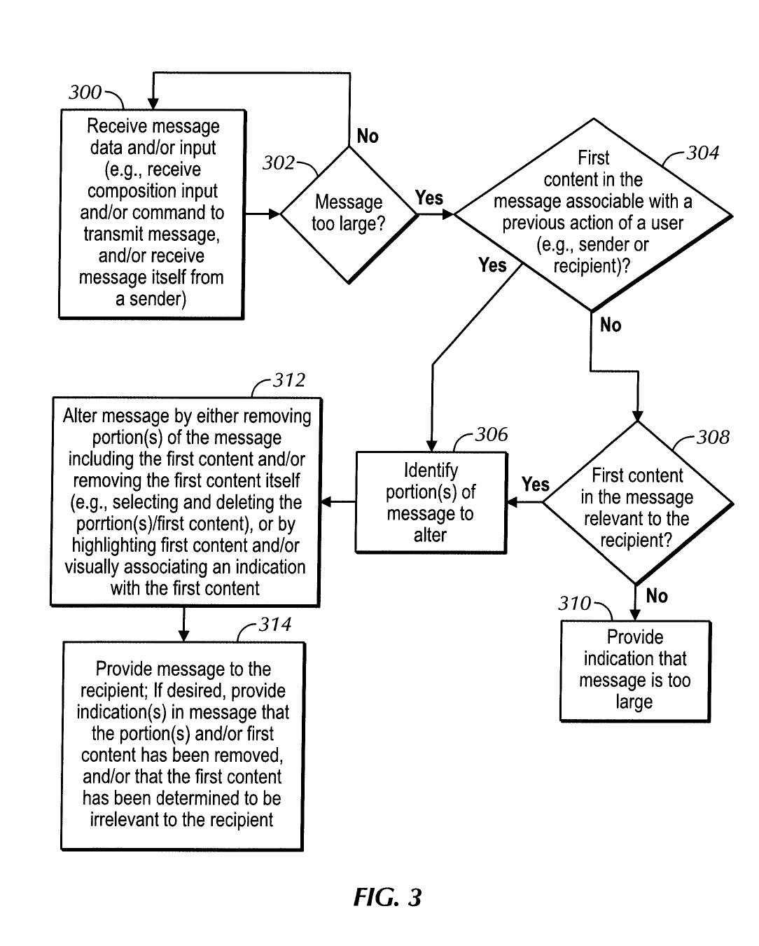

Referring to FIG. 3, it shows example logic that may be executed by a device such as the system 100 in accordance with present principles (referred to when describing FIG. 3 as the “present device”). It is to be understood that the logic of FIG. 3 may be executed by a device from which a message is to be transmitted and may also be executed by a device at which a message is to be received, as well as by a server facilitating message transmission and/or hosting a messaging account to which the message is sent. Beginning at block 300, the present device may receive message data and/or input pertaining to a message such as an email, a text message, a direct message, an instant message, etc. If the message is being composed at the present device, the message data/input may include message composition input and/or a command to transmit the message. If the message is being received at the present device, the message data/input may be receipt of the message itself.

Responsive to and/or based on receipt of the data and/or input at block 300, the present device may move to decision diamond 302 where the present device may determine whether the message as composed or received it too large. For example, if the message is being transmitted from the present device and the present device identifies a recipient and a data limit on messages the recipient is able to receive (e.g., based on data accessible to and/or stored at the present device, based on settings for the recipient's messaging account, etc.), the present device may determine whether the message being transmitted contains more data than the recipient's data limit and if the message is too large based on its data being over the data limit, an affirmative determination may be made at diamond 302.

As another example, if the message has been transmitted from the present device and the present device receives back an indication that the message was not successfully transmitted to the recipient because it exceeded the recipient's messaging account data limit, the present device may make an affirmative determination at diamond 302 and ultimately remove some content from the message and automatically send the message again as will be set forth further below (such as without additional input from the user other than the initial instance the user attempted to transmit the message for which the indication was then received). As yet another example, if the message is being received at the present device and it is determined based on the recipient's messaging account settings that the received message is too large, this may result in an affirmative determination at diamond 302 as well.

A negative determination at diamond 302 causes the present device to revert back to block 300 and proceed therefrom. Responsive to and/or based on an affirmative determination at diamond 302, the present device may next proceed to decision diamond 304. At diamond 304 the present device may determine whether at least first content in the message is associable with a previous action of a user (such as the sender and/or the recipient) and hence is relevant, and then move to block 306 responsive to an affiuinative determination or move to decision diamond 308 responsive to a negative determination. The determination at diamond 304 may be done using word recognition, image recognition, etc. to identify the first content and then compare the first content to data in a relational database, which may establish a history of previous actions of the sender and/or recipient, to determine whether the first content is associable with at least one previous action indicated in the relational database.

For example, if the first content is determined to include content having certain words and/or content of a certain content type that a sender typically (e.g., least a threshold amount of times) removes from a document before attaching it to the message as an attachment as determined based on data in a relational database, an affirmative determination may be made at diamond 304 and the present device may then proceed to block 306 where the present device may identify this content in an attachment that has been attached to the message being sent using keyword recognition and remove the first content without the user having to do so manually as set forth herein.

As another example, if the first content is determined to include certain sections of content that a recipient typically (e.g., least a threshold amount of times) removes from a type of document of the same document type as a particular document determined to be attached to a received message as determined based on data in a relational database, an affirmative determination may be made at diamond 304 and the present device may then proceed to block 306 where the present device may identify a section in the attachment (e.g., a sentence, a paragraph, a document section) that is similar to or the same as sections previously removed from documents of the same document type and remove the first content without the user having to do so manually as set forth herein.

As another example, if the first content is determined to include an attachment to a received message that is of a particular attachment type, and that attachments of the attachment type are typically not downloaded, opened, and/or viewed by the user (e.g., at all, or not more than a threshold number of times) when received in a message as may be determined based on a history of the recipient's previous actions, an affirmative determination may be made at diamond 304 and the present device may then proceed to block 306 where the present device may identify the attachment of the particular type and remove the attachment as described herein.

As indicated above, a negative determination at diamond 304 causes the present device to move to decision diamond 308. At diamond 308 the present device may determine whether the first content in the message is relevant to the recipient. An affirmative determination causes the present device to move to block 306, while a negative determination causes the present device to move to block 310. The determination at diamond 308 may be made based on, for instance, input from the recipient and/or settings pertaining to the recipient specifying types of content that are relevant to the recipient to determine whether the first content pertains to content of one of the types the user has indicated as being relevant.

The determination may also be made based on data associated with the user that is accessible to the present device. For example, the device may identify the recipient's job title (e.g., from a previous email), identify a word in the job title, and then correlate that word to types of content indicated in a relational database as being associated with the word and hence relevant.

As another example, the present device may determine that messages having a particular type of content or pertaining to a particular subject have been emailed to other people by the recipient, and/or have been opened and read by the recipient himself or herself, such as using a keyword identification and correlation algorithm. The present device may then determine whether the first content comprises the particular type of content and/or pertains to the particular subject and if so, the present device may make an affirmative determination at diamond 308. Such correlations may also be done based on data pertaining to past Internet searches of the recipient, mutatis mutandis.

As indicated above, a negative determination at diamond 308 may cause the present device to proceed to block 310, where the present device may provide an indication that the message being sent or received is too large to be respectively sent or received. However, as also indicated above, an affirmative determination at diamond 308 may cause the present device to move to block 306 where the present device may identify portions of the message (such as one including the first content) to alter such as by removing the content or by highlighting the content. From block 306 the present device may then proceed to block 312.

At block 312 the present device may alter the message by removing one of more portions of the message including the first content and/or removing the first content itself Alternatively, the present device may alter the message by highlighting one or more portions of the message including the first content and/or the first content itself, and/or by visually associated an indication with the first content. Examples of such indications will be discussed further below.

Regarding removing one or more portions of the message and/or the first content itself, the present device may do so by selecting the portions and/or first content and then deleting them from the message. Regarding highlight the first content, the present device may highlight the one or more portions and/or first content itself by inserting a colored box (e.g., of a neon color) into the background of parts of message presenting portions and/or first content such that the first content appears in to be in and surrounded by a highlighted box of a different color than other portions of the background. As another example of highlighting, underlining may be used as well as changing the color of text in the one or more portions and/or first content.

From block 312 the present device may move to block 314 where the present device may provide the message to the recipient, either by transmitting the message to the recipient if the present logic is executed by a sender's device or by making the message accessible for viewing to the recipient if the logic is executed by the recipient's device. In examples where content is removed from such a message, the remainder of the message may be provided to the recipient. In examples where content is highlighted in such a message, the message with highlighting may be provided to the recipient.

Also at block 314, the present device may provide one or more indications separately from the message and/or in the message itself indicating the content that has been removed from the message in the case where content is removed from the message, or indicating that content highlighted in the message has been determined to be irrelevant to the recipient and may be removed in the case where content in the message is highlighted.

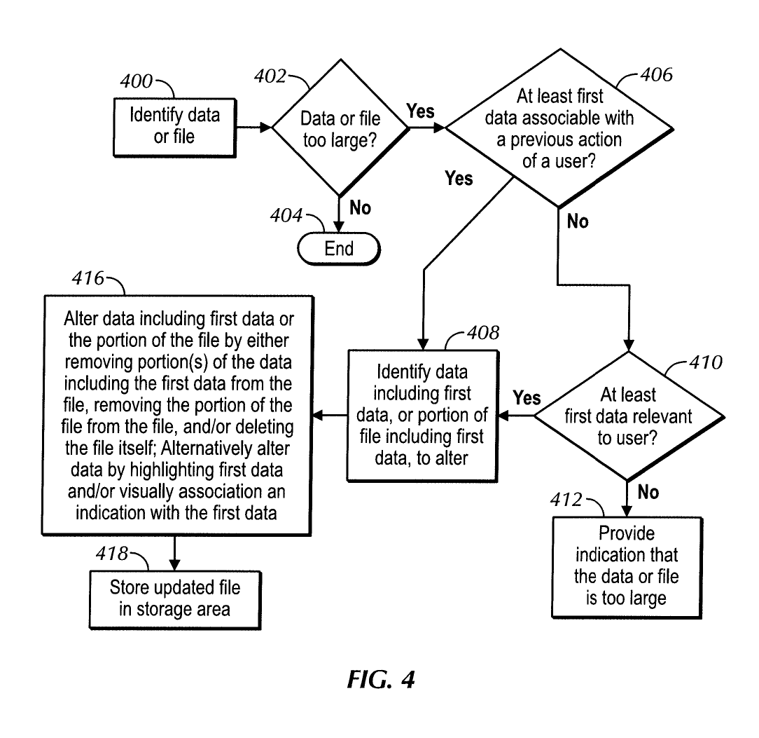

Now referring to FIG. 4, it also shows example logic that may be executed by a device such as the system 100 in accordance with present principles (referred to when describing FIG. 4 as the “present device”). It is to be understood that the logic of FIG. 4 may be executed by any device at which data is stored, that is to store data, and/or that is to provide data to another device for storage. Thus, beginning at block 400, the present device may identify or select data and/or a file (referred to below as a “file” for simplicity) that is stored at the present device, accessible to the present device, and/or for which the present device is being used to facilitate storage the thereof. The present device may perform the identification and/or selection based on a user command to do so, and/or automatically responsive to a command to access the file and/or store the file, for instance.

The present device may then proceed to decision diamond 402 where the present device may determine whether the file is too large, such as based on data limits for storage of individual files set by the user, based on an amount of available storage and hence whether the file is too large to be stored given the available storage, etc. A negative determination at diamond 402 causes the present device to proceed to block 404 where the file may be stored and/or the logic may end. An affirmative determination at diamond 402 instead causes the present device to proceed to decision diamond 406. At diamond 406 the present device may determine whether at least first data in the file is associable with a previous action of a user. The present device may do so similar to as described above in reference to diamond 304 of FIG. 3, mutatis mutandis.

An affirmative determination at diamond 406 may cause the present device to proceed to block 408 where the present device may identify data including the first data, or a portion of the file including the first data, which is to be altered in accordance with present principles. However, a negative determination at diamond 406 may instead cause the present device to proceed to diamond 410 where the present device may determine whether first data is relevant to the user. The present device may do so similar to as described above in reference to diamond 308 of FIG. 3, mutatis mutandis.

A negative determination at diamond 410 may cause the present device to proceed to block 412 where the present device may provide an indication at the present device that the file is too large. An affirmative determination at diamond 410 may cause the present device to proceed to block 408 and identify data to alter as described above. The present device may then proceed to block 416 where the present device may alter data including the first data and/or the portion of the file including the first data by either removing the data including the first data and/or removing the portion including the first data. Alternatively, the present device may alter the data by deleting the file itself. In yet another embodiment, the present device may alter the data by highlighting the first data and/or portions including the first data, and/or by visually associating an indication with the first data similar to as described above in reference to block 312 of FIG. 3, mutatis mutandis.

From block 416 the present device may then move to block 418. At block 418 the present device may store in a storage area the updated file that no longer includes the removed portion(s) and/or that includes the highlighting, assuming the file was not deleted at block 416. If the file was deleted at block 416, the logic may end at block 418.

Before moving on in the detailed description, it is to be understood in reference to FIG. 4 that the data and/or file may be a file already stored in a storage area and for which, e.g., the user has provided a command to remove irrelevant data.

However, the data and/or file may also be a file to be stored and/or that is in the process of being stored, and thus in some examples the logic of FIG. 4 may be executed automatically without further user input responsive to a command to store the data and/or file. In such an embodiment, the data and/or file may then be stored responsive to completion of the alteration performed at block 416.

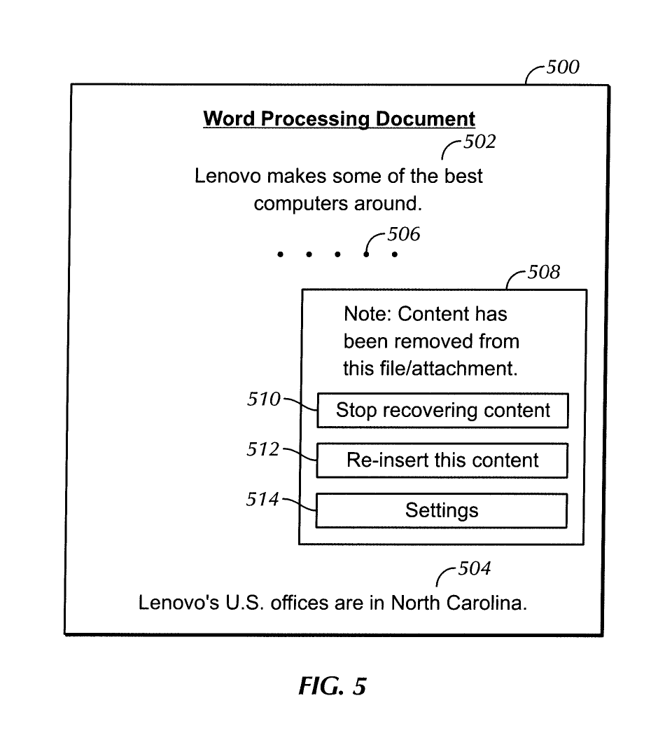

Continuing the detailed description in reference to FIG. 5, it shows a user interface (UI) 500 presenting a word processing document that has been altered in accordance with present principles. The word processing document may have been included as an attachment to a message or may have been stored in a storage area as disclosed herein. It is to be understood that, in this example, content mentioning the company Lenovo has been determined to be relevant and/or should remain in the word processing document based on one or more user actions. Thus, first content 502 is a sentence mentioning the keyword Lenovo, and content 504 is another sentence mentioning the key word Lenovo.

The UI 500 also shows a first indication 506 established by a series of dots that collectively establish a symbol indicating that other content has been removed from the word processing document. The UI 500 further shows a second indication 508 that indicates in words that other content has been removed from the word processing document. The indication 508 may be presented as a overlay or pop up window on the word processing document, and/or may be inserted into the document itself. As may be appreciated from FIG. 5, the indication 508 indicates that “content has been removed from this file/attachment” to a message that was received.

The indication 508 may also include a first selector 510 that is selectable to automatically without further user input configure the device that removed the content from this word processing document to stop removing content from messages, attachments, documents, and/or stored files in accordance with present principles. The indication 508 may include a second selector 512 as well, with the selector 512 being selectable to automatically without further user input configure the device that removed the content from this word processing document to reinsert the content that was removed from the document. This may be done such as if the device stored the removed content somewhere else, and/or may be done by re-downloading the document (e.g., from an email) or requesting the document again from the sender. A selector 514 is also shown that is selectable to configure the device to present a settings UI for configuring settings in accordance with present principles, such as the UI 800 to be described below.

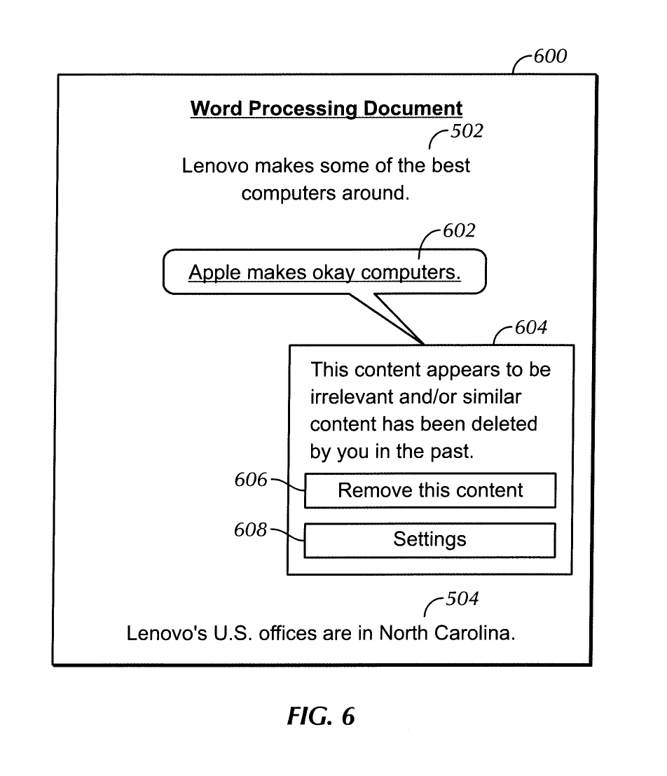

Continuing now in reference to FIG. 6, another UI 600 again presenting the word processing document described in reference to FIG. 5 is shown. It is to be understood that, in this example, content mentioning the company Lenovo has again been determined to be relevant and/or should remain in the word processing document based on one or more user actions. Thus, the first content 502 and second content 504 is again shown, with both mentioning the key word Lenovo.

Distinguishing FIG. 6 from FIG. 5, note that the word processing document as shown in the UI 600 also includes content 602 that a device has determined to be irrelevant to the user and/or possibly removable based on the user's past actions. The content 602 is highlighted in this example by underlining it with a wavy line. The content 602 is also altered by visually associating an indication 604 with the content 602. The indication 604 may comprise words indicating that the content 602 appears to be irrelevant and/or similar to content that the user has deleted in the past. The indication 604 also includes a selector 606 that is selectable to automatically without further user input remove the content 602 from the word processing document, as well as a selector 608 that is selectable to configure the device to present a settings UI for configuring settings in accordance with present principles, such as the UI 800 to be described below.

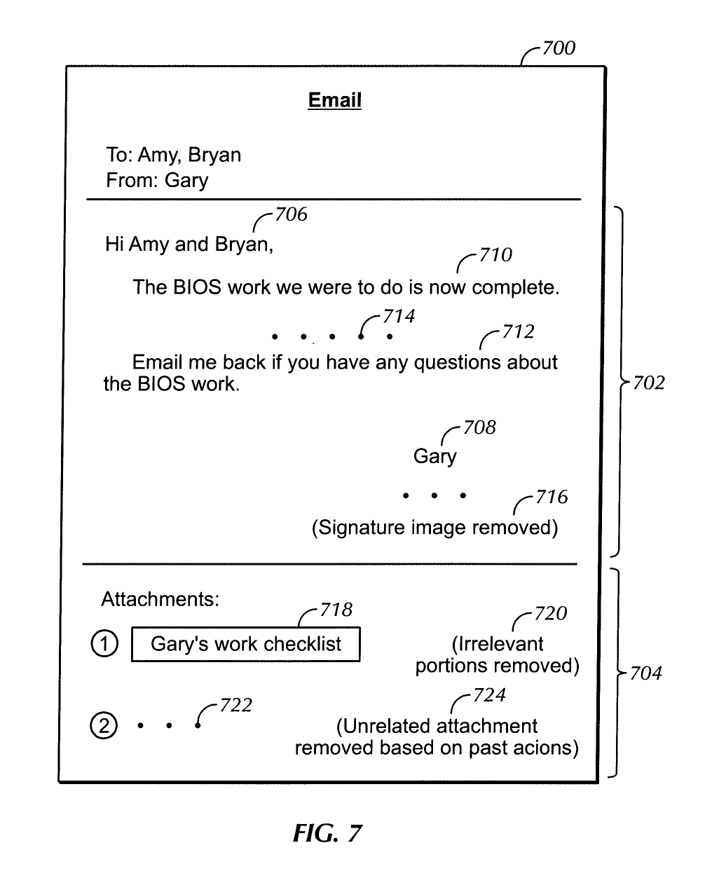

FIG. 7 shows an example UI 700 presentable on a display and presenting the content of an email transmitted to a device. The email includes a message body 702 and attachments 704. It has been addressed to two people, Amy and Bryan, and has been sent from Gary. It is to be understood that, in this example, the email as shown in FIG. 7 is presented on Amy's device and that certain portions of the message body 702 have been removed based on determinations of content relevant and irrelevant to Amy using Amy's job title as identified from a previous email indicating that she is a BIOS (basic input output system) engineer.

Thus, to as ensure that the message is receivable by Amy's email account per a predefined data limit for her email account, a server facilitating the transmission of the email to Amy (e.g., an email server hosting Amy's email account and/or storing her messages), and/or Amy's device itself, may remove at least some of the email's content such as an image, a portion of an attachment to the message, an entire attachment to the message, and/or at least a portion of a body of the message.

In this example, the email salutation 706 and other portions of a letter format not related to BIOS, such as the signature 708, may remain in the message body 702, but not other content that Gary wrote in the email besides the BIOS contents 710 and 712. In place of the other content that has been removed from the email, an indication 714 established by a series of dots indicates that other content has been removed from the email. Another indication 716, presented as words in parenthesis, indicates that an image in Gary's signature has been removed.

Referring to the attachments 704, note that a first attachment 718 that is selectable for download may be presented, but that indication 720 indicates that portions of the attachment irrelevant to Amy have been removed. Yet another indication 722 is presented where a second attachment Gary attached to the email would otherwise be, along with an indication 724 that the attachment was “unrelated” to Amy and removed based on Amy's past activities.

Still in reference to FIG. 7, it is to be understood that in at least some embodiments, the same email but as presented on Bryan's device and/or as delivered to Bryan's email account may include at least some or all of the content from Gary but removed from Amy's email as discussed above.

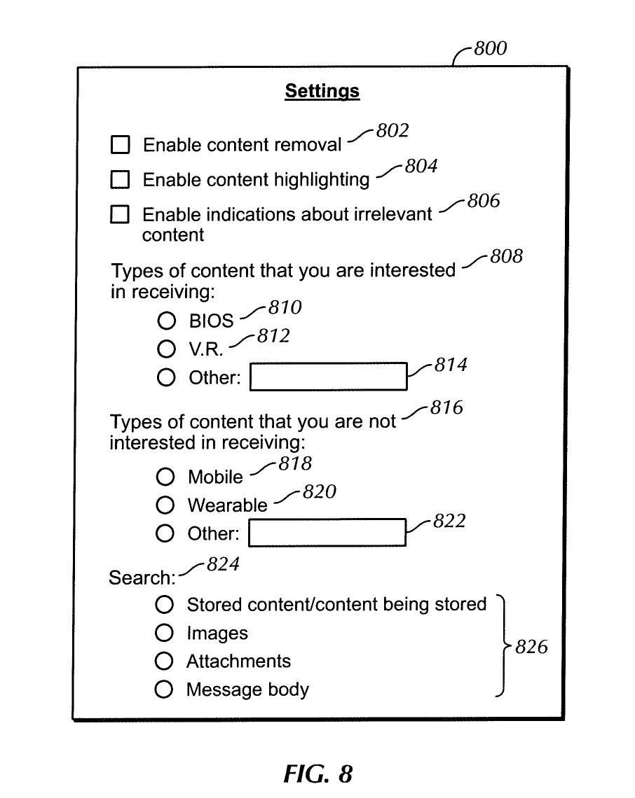

Now in reference to FIG. 8, it shows the settings UI 800 mentioned above that is presentable on a display of a device for configuring a device to undertake present principles, whether that be a device transmitting a message, a device receiving a message, and/or a messaging server facilitating messaging transmission. The UI 800 includes a first option 802 that is enableable by selecting the respective check box shown adjacent thereto. The option 802 is enableable to configure the device to remove content from messages and/or storage objects as set forth herein (e.g., based on the content being determined to be irrelevant).

If desired, the UI 800 may also include a second option 804 that is enableable by selecting the respective check box shown adjacent thereto to configure the device to highlight content in messages and/or storage objects as set forth herein (e.g., based on the content being determined to be irrelevant). If desired, the UI 800 may further include a third option 806 that is enableable by selecting the respective check box shown adjacent thereto to configure the device to present indications regarding irrelevant content as set forth herein.

The UI 800 of FIG. 8 may also include another option 808 that pertains to various types of content that the user may select as relevant in accordance with present principles. Example types include BIOS-related content 810 and virtual reality-related content 812, which are each selectable using the respective radio button shown adjacent thereto. A text entry field 814 is also presented at which a user may enter text to establish another type of content relevant to the user.

The UI 800 may further include an option 816 that pertains to various types of content that the user may select as irrelevant in accordance with present principles. Example types include mobile-related content 818 and wearable-related content 820, which are each selectable using the respective radio button shown adjacent thereto. A text entry field 822 is also presented at which a user may enter text to establish another type of content irrelevant to the user.

Still further, in some embodiments the UI 800 may include a setting 824 to select, using the respective radio buttons shown, one or more options 826 for storage objects and message areas to search for determinations of whether the content is irrelevant to the user and/or not desired to be viewed by the user based on the user's past actions. Example options 826 include content that is stored and/or is being stored, images (e.g., in a message), attachments to a message, and a body of the message itself.

In accordance with present principles, it is to be understood that storage objects and/or message attachments that may be stored may include not only word processing documents but also PowerPoint documents, PDF documents, etc. Furthermore, if a zip file is stored or attached to a message that is transmitted, the actual files themselves may be unzipped from the zip file and parsed for relevant/irrelevant content, and then the irrelevant content may be removed or highlighted from the unzipped files in accordance with present principles.

It may now be appreciated that present principles provide for selectively removing content in a document, file, or message based on a user's prior actions and/or relevant topics. For example, irrelevant content or pictures may be removed from a stored file or emailed message in order to save storage space. E.g., if a message recipient is a BIOS engineer, content in a technical specification that is not relevant to BIOS may be removed from the message to the recipient.

The foregoing may be triggered automatically by the user (e.g., based on sending or receiving the message itself, and/or responsive to a command to store a file). Additionally or alternatively, the sender or receiver may be presented with an option to never remove irrelevant content on certain messages, on messages from certain senders, on messages from particular email domain names, on messages received at certain times of days and/or days of the week, etc.

Furthermore, it is to be understood that although the highlighting of irrelevant content was discussed above, in some embodiments all content determined to be relevant may instead be highlighted with irrelevant content left not highlighted.

Even further, in some embodiments a scaling option may be used in which sections having content determined to be the least relevant may be removed first, and then increasingly relevant sections may be removed as a storage or message limit or quota is approached. In some embodiments, this scaling may be established based on a weighting of types of content that are relevant, with the weighting established based on user input.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor; and
storage accessible to the processor and bearing instructions executable by the processor to:
identify content in a message that is to altered;
alter the content in the message; and
provide at least a portion of the message to a recipient.

2. The device of claim 1, wherein the instructions are executable by the processor to:
identify content in the message that is to be altered by identifying content in the message that is to be removed from the message;
alter the content by removing the content from the message; and
provide at least a portion of the message by providing the remainder of the message to the recipient.

3. The device of claim 2, wherein the content in the message that is to be removed from the message is identified at least in part based on one or more of at least one previous action of the recipient and at least one previous action of a sender of the message.

4. The device of claim 2, wherein the content in the message that is to be removed from the message is identified at least in part based on whether the content is relevant to the recipient.

5. The device of claim 4, wherein the instructions are executable by the processor to determine whether the content is relevant to the recipient based on input from the recipient.

6. The device of claim 5, wherein the input is received at a user interface (UI) presented on a display, the UI comprising at least one option that is selectable and that pertains to relevance of a particular type of content.

7. The device of claim 1, wherein the content comprises one or more of: an image, a portion of an attachment to the message, an attachment to the message, and at least a portion of a body of the message.

8. The device of claim 1, wherein the device is selected from the group consisting of: a device transmitting the message, a server, a device receiving the message.

9. The device of claim 2, wherein the instructions are executable by the processor to:
provide an indication to the recipient that content has been removed from the message.

10. The device of claim 2, wherein the content is removed by deleting the content from the message.

11. The device of claim 2, wherein the instructions are executable by the processor to:
present a user interface (UI) on a display at which an option is enableable to set the device to stop removing content from at least some messages.

12. The device of claim 2, wherein the content is removed from the message responsive to an indication that the message is too large to be one or more of transmitted and received.

13. A method, comprising:
identifying content in a message that is to be altered;
altering the content in the message; and
providing at least a portion of the message to a recipient.

14. The method of claim 13, wherein the content is altered by removing the content from the message, and wherein the remainder of the message is provided to the recipient.

15. The method of claim 13, wherein the content is altered at least in part by highlighting the content.

16. The method of claim 13, wherein the method comprises providing an indication that the content has been determined to be irrelevant and wherein the content is altered by visually associating the indication with the content.

17. The method of claim 13, wherein the content is identified at least in part based on data in a history, the history pertaining to previous actions of the recipient.

18. The method of claim 13, wherein the content is identified at least in part based on determining whether the content is relevant to the recipient.

19. The method of claim 13, comprising:
providing an indication to the recipient that content has been removed from the message.

20. A computer readable storage medium that is not a transitory signal, the computer readable storage medium comprising instructions executable by a processor to:
identify data that is to be altered based at least in part on one or more of a whether the data is relevant to a user and at least one previous action of the user; and
alter the data based on the identification.

21. The computer readable storage medium of claim 20, wherein the data forms at least a portion of a message, and wherein the instructions are executable by the processor to:
provide, to a recipient, portions of the message excluding the data.

22. The computer readable storage medium of claim 20, wherein the data, prior to alteration, formed at least a first portion of a file, and wherein the instructions are executable by the processor to:
store, in a storage area, other portions of the file that do not include the data.
